(19) United States
(12) Patent Application Publication
(10) Pub. No.: US 2006/0117075 A1
(43) Pub. Date: Jun. 1, 2006

(54) Prerequisite, dependent and atomic deltas

(75) Inventors: Scott Cowan, Ottawa (CA); Mohammed Ibrahim Mostafa, Kanata (CA); Frederic Plante, Chelsea (CA)

Correspondence Address: CUENOT & FORSYTHE, L.L.C., 12230 FOREST HILL BLVD., STE. 171, WELLINGTON, FL, 33414, US

(73) Assignee: INTERNATIONAL BUSINESS MACHINES CORPORATION, Armonk, NY (US)

(21) Appl. No.: 11/000,744

(22) Filed: Dec. 1, 2004

(51) Int. Cl. G06F 17/30

(52) U.S. Cl. 707/203

(57) ABSTRACT

A method of merging a plurality of different versions of an electronic document during a software development process can include identifying the plurality of different versions of the electronic document. The electronic document can have a defined structure. The method further can include determining a plurality of deltas between the different versions and determining relationships, between individual ones of the plurality of deltas according to the defined structure of the electronic document. One or more of the plurality of deltas can be selectively accepted in a merged electronic document according to the determined relationships.

### BACKGROUND

1. Field of the Invention

The present invention relates to software development and, more particularly, to software development tools.

2. Description of the Related Art

Modern software is complex in nature and typically is formed of a collection of many different documents. Because the size and complexity of the documents themselves can be significant, it is common practice to assign responsibility for developing and maintaining each document to a team of developers. When two developers change the same document, it becomes necessary to combine the contributions of each individual and/or team into a single document that is to be incorporated into a software build.

A software-based tool, referred to as a merge tool, is capable of combining the contributions of different individuals or teams into a merged document. Generally, the merge tool automatically compares two or more documents, whether different documents to be combined or different versions of a same document. The documents can be individual files including, but not limited to, source code files, modeling language files, or other electronic documents. Any differences between the compared documents, called deltas, are identified by the merge tool. Each delta can be a software object or other data structure that specifies one or more changes to be made to a baseline document.

Conventional merge tools can accept deltas generated from a comparison of two or more documents and write the changes into a merged document. Deltas that are accepted are implemented upon the baseline document to generate the merged document. In doing so, the merge tool typically performs a limited analysis as to whether the deltas identified from each different version of the document conflict with one another. Such analysis can include a line-by-line comparison between the documents to be merged or, in some cases, a “chunk” analysis. The merge tool, however, does not analyze the structure of a document to determine dependencies and internal references to ensure that integrity of the merged document is maintained.

In illustration, when merging two or more different versions of a source code document, one developer may add a reference to an existing method, while another developer may delete that same method. The two deltas would be identified by a conventional merge tool. Because the changes occur in different portions of the document, however, a conventional merge tool would not detect that the reference was broken. That is, the analysis performed by a conventional merge tool would not detect that the contribution from one developer relied upon a portion of the source code that another developer removed or deleted. In consequence, both deltas would be accepted into the merged document. This results in a merged document with a reference to a method that no longer exists. The merged document no longer maintains referential integrity.

This is but a single example of the sort of problem that can arise using a conventional merge tool. As conventional merge tools have no syntactic or semantic understanding of the text that is being merged, detecting such errors during a merge operation is problematic. Errors of this variety would not be detected until the source code is compiled. Compilation, however, occurs at a later time in the development process than merging, thereby delaying the point at which developers are made aware of any potential problems. Late detection introduces additional cost and time to the development process.

### SUMMARY OF THE INVENTION

The present invention provides a solution for merging electronic documents into a merged document. One embodiment of the present invention can include a method of merging a plurality of different versions of a structured electronic document. The method can include identifying the plurality of different versions of the electronic document, wherein the electronic document has a defined structure. The method further can include determining a plurality of deltas between the different versions and determining relationships between individual ones of the plurality of deltas according to the defined structure of the electronic document. One or more of the deltas can be selectively accepted to create a merged electronic document according to the determined relationships.

Another embodiment of the present invention can include a machine readable storage being programmed to cause a machine to perform the various steps described herein.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system for merging electronic documents in accordance with one embodiment of the present invention.

FIG. 2 is a table illustrating deltas identified from a comparison of different versions of an electronic document to be merged in accordance with another embodiment of the present invention.

FIG. 3 is a directed graph illustrating prerequisite relationships as specified by the table of FIG. 2.

FIG. 4 is a directed graph illustrating dependent relationships as specified by the table of FIG. 2.

FIG. 5 is a table illustrating deltas identified from a comparison of different versions of an electronic document to be merged in accordance with another embodiment of the present invention.

FIG. 6 is a directed graph illustrating prerequisite relationships as specified by the table of FIG. 5.

FIG. 7 is a directed graph illustrating dependent relationships as specified by the table of FIG. 5.

FIG. 8 is a flow chart illustrating a method of merging electronic documents in accordance with another embodiment of the present invention.

### DETAILED DESCRIPTION OF THE INVENTION

The present invention provides a solution for merging electronic documents. In one embodiment of the present invention, conflicting deltas can be identified and notification can be provided thereby alerting a developer to the existence of a conflict. Such notification allows developers to implement any needed edits to the electronic documents being merged prior to progressing to the next stage of the development process. In another embodiment, relationships between deltas, such as whether one delta is dependent upon, or a prerequisite of, another delta can be identified. A set of rules can be applied to determine which deltas are to be accepted or rejected from a merged document.

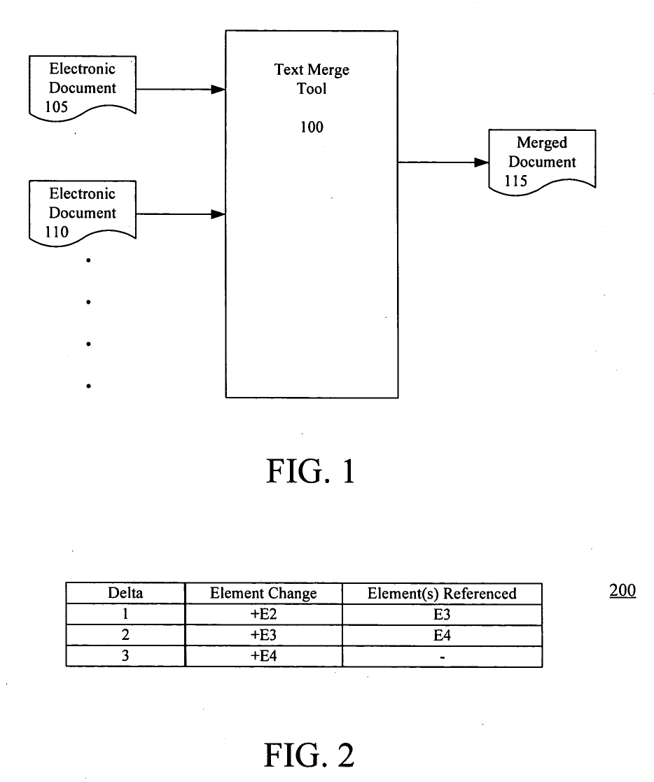

FIG. 1 is a schematic diagram illustrating a system for merging electronic documents in accordance with one embodiment of the present invention. The term document, as used herein, can refer to a software module or other structured electronic file. The file can specify text including, but not limited to, source code, computer-based description language, scripting language, and/or modeling language. In one embodiment, for example, the documents can be individual portions of a larger program written in the JAVA programming language. Other programming languages, however, whether high or low level, can be used as well. In another embodiment, the documents can include Universal Modeling Language (UML), which is a standard for expressing object-oriented analysis and design decisions. Such documents can be, or can be derived from, source code files. In this case, documents 105 and 110 can be different versions of a same file.

The merge tool 100 can be implemented as one or more computer programs executing within a suitable information processing system such as a desktop computer system, a laptop computer system, a server, or the like (hereafter “computer system”). As shown, the merge tool 100 can obtain one or more documents 105 and 110. The merge tool 100 can include a set of rules for identifying differences or changes, referred to as deltas, between documents 105, 110. The rules also can specify the order and manner in which the deltas are to be accepted to generate a merged document 115. The rules used by the merge tool 100 are described in further detail with reference to FIGS. 2-7. In any case, the rules provide the merge tool with semantic and syntactic knowledge pertaining to the structure of the documents to be processed.

Typically one of the documents 105, 110 is selected as a baseline document. In this case, for example, document 105 can be selected as the baseline document. Accordingly, document 110 is compared, by the merge tool 100, with the baseline document 105. Any deltas identified between the two documents 105 and 110 can be expressed from the perspective of the baseline document 105. That is, if a comparison of the baseline document 105 with the document 110 indicates that document 110 includes a construct that is missing from baseline document 105, an add delta can be generated. The add delta specifies that the software construct that is included in document 110, but missing from baseline document 105, is to be added to the baseline document 105. Similarly, if the baseline document 105 includes a software construct that is missing from document 110, a delete delta can be generated. The delete delta specifies that the software construct in baseline document 105 that is not included in document 110 is to be deleted from baseline document 105.

Other varieties of deltas can include change deltas and move deltas. A change delta can indicate that a particular software construct in the baseline document 105 differs from the same or parallel construct in document 110. Though the constructs differ from one another in some respect, the two can be located in the same relative position within each document. A change delta can specify that the software construct in baseline document 105 is to be changed to match its corresponding software construct in document 110.

A move delta can indicate that a particular software construct in baseline document 105 is located in a different relative position as compared with the position of the same software construct in document 110. The move delta can specify that the software construct in baseline document 105 is to be moved to correspond to the location of the software construct in document 110.

A software construct, or construct, refers to a data structure used for a particular purpose. A construct can refer to a single programming language statement or a collection of more than one statement such as a loop, method, function, or the like, where the collection has a particular function. Constructs also are defined by organizations such as the Institute of Electrical and Electronics Engineers (IEEE) and the American National Standards Institute (ANSI). These organizations set forth standards for different computer-based programming, scripting, and/or modeling languages such as C, C++, and the like.

FIG. 2 is a table 200 illustrating deltas identified from a comparison of different versions of a document to be merged in accordance with another embodiment of the present invention. As shown, the first column of table 200 indicates a delta reference number of 1, 2, or 3. Column 2, entitled “Element Change”, indicates the changes specified by each delta. In this case, each delta is an add delta signified by the “+” sign prefix. The notation “E” refers to an element, which can be a shorthand for any of a variety of different software constructs as previously described.

The third column of table 200, having the heading “Element(s) Referenced”, specifies the particular element, or elements, that are referenced by the element to be added. The elements in the “Element(s) Referenced” column are also subjects of identified deltas. That is, the referenced elements also have been identified for addition or deletion. Thus, delta 1 is an add delta specifying that element 2, or E2, is to be added. +E2 includes a reference to E3 as indicated by table 200. Delta 2 is an add delta specifying that E3 is to be added. +E3 includes a reference to E4. Delta 3 is an add delta specifying that E4 is to be added. +E4 does not include a reference to another delta.

From reviewing table 200, it should be noted that the relationship between deltas and the elements referenced by the deltas must be observed to maintain the integrity of the references. That is, if+E2 is accepted for inclusion to the merged document, +E3 also must be accepted as +E2 references E3. Continuing, if+E3 is to be accepted, so too must E4 as +E3 references E4.

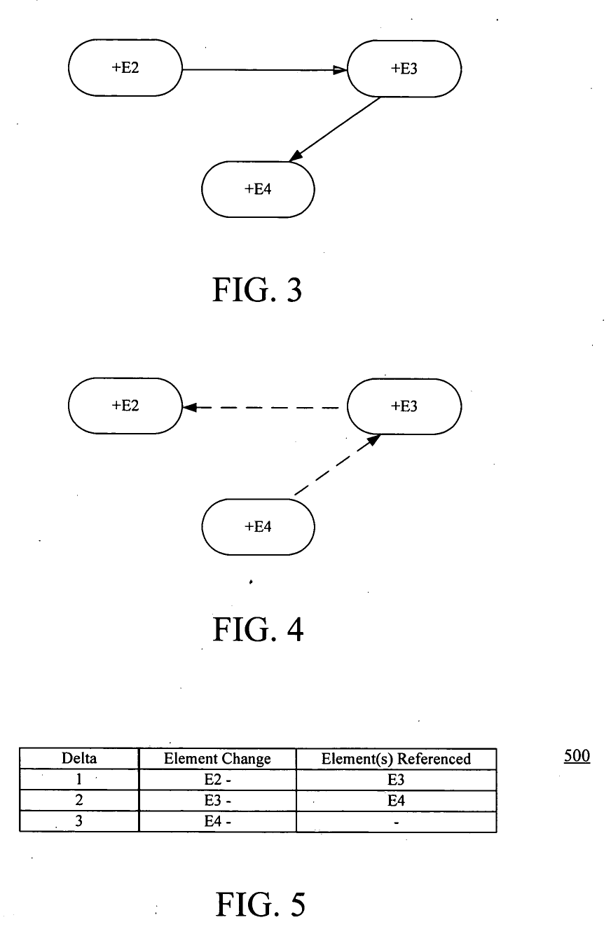

FIG. 3 is a directed graph illustrating prerequisite relationships as specified by the table of FIG. 2 and as indicated by the solid-lined arrows connecting the deltas. FIG. 3 depicts prerequisite add delta relationships and rules for handling such deltas. Prerequisite add relationships must be observed to maintain the integrity of the references when add deltas are accepted by the merge tool. A prerequisite add delta relationship can be defined as follows: given two add deltas D1 and D2, D1 is a prerequisite of D2 if D1 encompasses an added element that is referenced by an added element encompassed by D2.

Generally, if a particular add delta, referred to as a target add delta, is considered for acceptance to the merged document, all of the prerequisite add deltas for the target add delta must be accepted first. The target delta and any prerequisite deltas of the target can be considered an atomic unit to be accepted as a group. FIG. 3 indicates that if delta +E2 is selected as the target and considered for acceptance, then deltas +E4 and +E3 must be accepted. Delta +E4 must be accepted first followed by delta +E3. If delta +E3 is selected as the target and considered for acceptance, delta +E4 must be accepted first. Thus, delta +E4 is a prerequisite of delta +E3. Similarly, delta +E3 is a prerequisite of delta +E2. In this example, if delta +E3 is accepted, it is not necessary to accept delta +E2. Similarly, if delta +E4 is accepted, is not necessary to accept either delta +E3 or +E2.

FIG. 4 is a directed graph illustrating dependent relationships as specified by the table of FIG. 2 as indicated by the dashed lines. FIG. 4 depicts dependent add relationships and rules for handling such deltas. These dependent add relationships must be observed to maintain the integrity of the references when, or if, the add deltas are rejected by the merge tool. A dependent add delta relationship can be defined as follows: given two add deltas D1 and D2, D2 is a dependent of D1 if D1 is a prerequisite of D2. In general, to reject a target add delta, all of the add deltas that are dependent upon the target add delta must be rejected prior to the target delta. The target delta and any dependent add deltas can be considered an atomic unit to be rejected as a group.

FIG. 4 illustrates that delta +E2 is dependent upon delta +E3 and delta +E3 is dependent upon delta +E4. In illustration, if delta +E3 is selected as the target delta and considered for rejection, delta +E2 must be rejected prior to the target. Notably, delta +E4 need not be rejected in this case. If delta +E4 is selected as the target and considered for rejection, delta +E2 must be rejected first, followed by delta +E3. Both deltas +E2 and +E3 are rejected prior to the target delta +E4. In another example, if delta +E2 is selected as the target and considered for rejection, neither delta +E3 nor delta +E4 need be rejected.

The table below depicts an example merge between two documents, version 1 and version 1.1, where version 1 is the baseline document. The merge identifies deltas +E2, +E3, and +E4 when comparing the two versions. While the example shown below illustrates the case where documents are specified in a markup language format, such as Extensible Markup Language (XML), it should be appreciated that the present invention is not so limited. For example, the present invention can be applied to database schemas or to any binary data.

| Version 1 (Baseline) | Deltas | Version 1.1 |
|---|---|---|
| <element id=“1”> | | <element id =“1”> |
| | +E2 | <element id“2” ref=“3”/> |
| | +E3 | <element id“3” ref=“4”/> |
| | +E4 | <element id“4”/> |
| </element> | | </element> |

FIG. 5 is a table 500 illustrating deltas identified from a comparison of different versions of a document to be merged in accordance with another embodiment of the present invention. As shown, table 500 illustrates another set of deltas 1, 2, and 3. In this case, each delta is a delete delta signified by the “−” sign suffix following the element description. The third column of table 500 specifies the particular element that is referenced by each the element to be deleted. As noted, elements listed in the “Element(s) Referenced” column are also subjects of identified deltas. That is, the referenced elements also have been identified for deletion.

Thus, delta 1 is a delete delta specifying that E2 is to be deleted. E2 references another element E3. Delta 2 is a delete delta specifying that E3 is to be deleted. E3− includes a reference to E4. Delta 3 is a delete delta specifying that E4 is to be deleted. E4− includes no reference to another element. The relationship between identified deltas and elements listed in the “Element(s) Referenced” column, i.e. those elements referenced by elements to be deleted, must be observed to maintain the integrity of the references. Thus, if delta E3− is accepted in the merge document—meaning that delta E3 is to be deleted, delta E2− also must be accepted thereby causing the removal of delta E2.

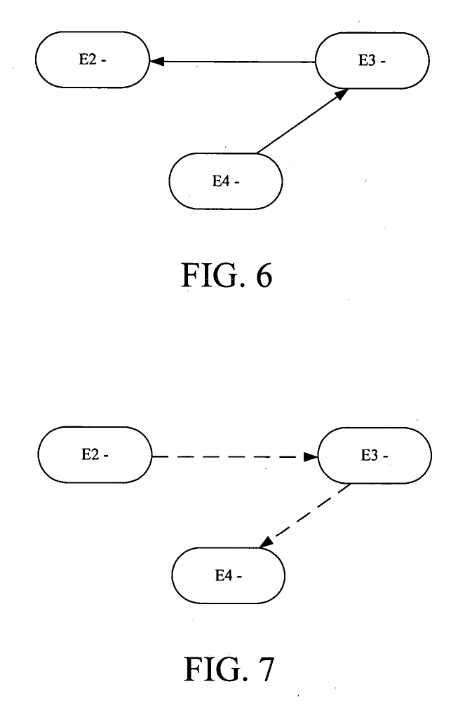

FIG. 6 is a directed graph illustrating prerequisite relationships as specified by the table of FIG. 5. FIG. 6 depicts prerequisite delete delta relationships and corresponding rules. Prerequisite delete delta relationships must be observed to maintain the integrity of references when a delete delta is accepted. A prerequisite delete delta relationship can be defined as follows: given two delete deltas D1 and D2, D1 is a prerequisite of D2 if D1 encompasses a deleted element that references a deleted element encompassed by D2.

In general, if a delete delta is selected as a target and considered for acceptance, all of the prerequisite delete deltas of the target must be accepted prior to accepting the target. The target delete delta and any prerequisite delete deltas can be considered an atomic unit that are accepted as a group. As shown in FIG. 6, delta E2− is a prerequisite of delta E3−, and delta E3− is a prerequisite of delta E4−. Thus, if delta E3− is selected as a target and considered for acceptance, delta E2− must be accepted first. Delta E4−, however, need not be accepted. If delta E4− is selected as the target and considered for acceptance, delta E2− must be accepted first, followed by delta E3−, and then delta E4−. Finally, if delta E2− is selected as the target and considered for acceptance, neither delta E3− nor delta E4− need be accepted prior to delta E2−.

FIG. 7 is a directed graph illustrating dependent relationships as specified by the table of FIG. 5. FIG. 7 depicts dependent delete delta relationships and rules for handling such relationships. A dependent delete delta relationship can be defined as follows: given two delete deltas D1 and D2, D2 is a dependent of D1 if D1 is a prerequisite of D2. In general, if a delete delta is selected as a target delta and considered for rejection, all of the dependent delete deltas of that target delta must be rejected first. The target delete delta and the dependent delete deltas of the target can be considered an atomic unit that is to be rejected as a group.

As illustrated by FIG. 7, if delta E3− is selected as a target and considered for rejection, delta E4− must be rejected prior to the target. It is not necessary, however, to reject delta E2−. If delta E2− is rejected, then delta E4− must be rejected first, then delta E3−, followed by delta E2−. If delta E4− is selected as a target and considered for rejection, neither delta E3− nor delta E4− need be rejected.

The table below depicts an example merge between two documents, version 1 and version 1.1, where version 1 is the baseline document. The merge identifies deltas E2−, E3−, and E4− when comparing the two versions. As noted, though the example shown illustrates the case where documents are specified in a markup language format, it should be appreciated that the present invention is not so limited.

| Version 1 (Baseline) | Deltas | Version 1.1 |
|---|---|---|
| <element id“1”> | | <element id=“1”> |
| <element id“2” ref=“3”/> | E2- | |
| <element id“3” ref=“4”/> | E3- | |
| <element id“4”/> | E4- | |
| </element> | | </element> |

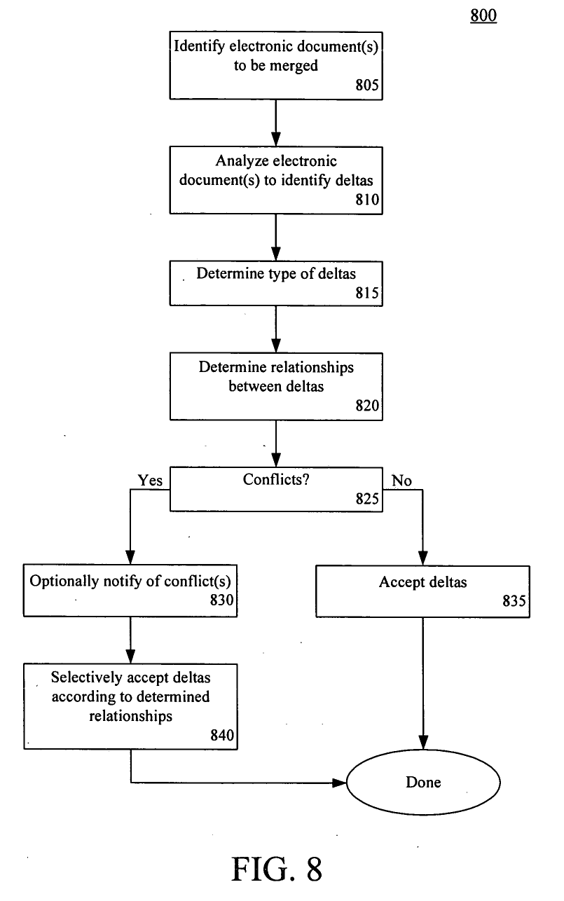

FIG. 8 is a flow chart illustrating a method 800 of merging different versions of a document in accordance with another embodiment of the present invention. The method 800 can be performed by the merge tool described with reference to FIG. 1. The method 800 can begin in step 805, where two or more documents to be merged can be identified. As noted, the documents can be different versions of the same document. In step 810, the different versions of the document can be analyzed to identify the deltas between each version, using one version as a baseline document.

In step 815, the merge tool can determine the type of each delta identified. For example, each delta can be classified as a delete delta or an add delta as the case may be. In step 820, the relationships between the identified deltas can be determined. That is, deltas can be classified as dependent or prerequisite with reference to other deltas referred to as target deltas. It should be appreciated that while directed graphs, as described herein, can be constructed for purposes of classifying delta relationships, such data structures need not be generated.

In step 825, a determination can be made as to whether any deltas conflict with one another. The determination as to whether a conflict exists can be made based upon the relationships identified between the deltas. For example, if one delta specifies the removal of an element that is referenced by an element added by another delta, a conflict exists. The determination can be made as the merge tool has semantic and syntactic processing ability with respect to documents having a defined structure. The structure can be defined by the document type or type of text and/or language included therein. If a conflict exists, the method can proceed to step 830. If not, the method can proceed to step 835 where the deltas can be accepted.

In step 830, the merge tool optionally can provide an audible and/or visual notification of the conflict. Further, the merge tool can provide a description of the nature of the conflict. The description can include information such as the conflicting deltas, elements referenced by the conflicting deltas, elements to be added or removed in consequence of the conflicting deltas, broken references, and the like. The computer operator also can be presented with a choice as to whether to allow the merge tool to continue with an automated merge according to the rules described herein or halt the merge process. Thus, if so desired, the operator can halt processing in favor of editing the documents to correct the identified conflict(s).

In step 840, deltas can be selectively accepted into a merged document according to the relationships. For example, all prerequisite deltas of a given target delta can be recursively accepted prior to accepting the target delta. All dependent deltas of a given target delta can be recursively rejected prior to accepting the target delta. The merge tool can apply the rules described herein to determine whether to accept and/or reject particular deltas. As noted, using the rules described herein, particular collections of one or more deltas can be considered atomic units that can be accepted or rejected as a group.

The inventive arrangements disclosed herein provide a solution for performing merging upon two or more documents. Generally, the merge tool is programmed with knowledge of the constructs and structure of the text and/or document type to be merged. Accordingly, the merge tool can identify deltas, apply one or more rules to identify relationships among the deltas, and selectively accept or reject deltas in accordance with the rules and/or relationships. As such, the present invention can merge two or more documents, or different versions of a document, such that the integrity of references within those documents is maintained.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program or software, in the present context, means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method of merging a plurality of different versions of an electronic document during a software development process, said method comprising:
identifying the plurality of different versions of the electronic document, wherein the electronic document has a defined structure;
determining a plurality of deltas between the different versions;
determining relationships between individual ones of the plurality of deltas according to the defined structure of the electronic document; and
selectively accepting at least one of the plurality of deltas to create a merged electronic document according to the determined relationships.

2. The method of claim 1, said step of determining relationships comprising identifying at least one delta from the plurality of deltas as a prerequisite delta with respect to a target delta.

3. The method of claim 2, said step of selectively accepting deltas comprising recursively accepting all prerequisite deltas prior to accepting the target delta.

4. The method of claim 1, said step of determining relationships comprising identifying at least one delta from the plurality of deltas as a dependent delta with respect to a target delta.

5. The method of claim 4, said step of selectively accepting deltas comprising recursively rejecting all dependent deltas prior to rejecting the target delta.

6. The method of claim 1, said step of determining relationships comprising identifying at least a first delta from the plurality of deltas as a prerequisite delta or a dependent delta.

7. The method of claim 6, further comprising identifying the at least a first delta as an add delta.

8. The method of claim 6, further comprising identifying the at least a first delta as a delete delta.

9. The method of claim 6, further comprising identifying the at least a first delta as a move delta.

10. The method of claim 6, further comprising identifying the at least a first delta as a change delta.

11. The method of claim 1, further comprising:
prior to said step of selectively accepting deltas, detecting a conflict between at least two deltas; and
providing a notification of the conflict.

12. A machine readable storage, having stored thereon a computer program having a plurality of code sections executable by a machine for causing the machine to perform the steps of:
identifying a plurality of different versions of an electronic document, wherein the electronic document has a defined structure;
determining a plurality of deltas between the different versions;
determining relationships between individual ones of the plurality of deltas according to the defined structure of the electronic document; and
selectively accepting at least one of the plurality of deltas to create a merged electronic document according to the determined relationships.

13. The machine readable storage of claim 12, said step of determining relationships comprising identifying at least one delta from the plurality of deltas as a prerequisite delta with respect to a target delta.

14. The machine readable storage of claim 13, said step of selectively accepting deltas comprising recursively accepting all prerequisite deltas prior to accepting the target delta.

15. The machine readable storage of claim 12, said step of determining relationships comprising identifying at least one delta from the plurality of deltas as a dependent delta with respect to a target delta.

16. The machine readable storage of claim 15, said step of selectively accepting deltas comprising recursively rejecting all dependent deltas prior to rejecting the target delta.

17. The machine readable storage of claim 12, said step of determining relationships comprising identifying at least a first delta from the plurality of deltas as a prerequisite delta or a dependent delta

18. The machine readable storage of claim 17, further comprising identifying the at least a first delta as at least one of an add delta and a delete delta.

19. The machine readable storage of claim 17, further comprising identifying the at least a first delta as at least one of a change delta and a move delta.

20. The machine readable storage of claim 12, further comprising:
prior to said step of selectively accepting deltas, detecting a conflict between at least two deltas; and
providing a notification of the conflict.
